(19) United States
(12) Patent Application Publication
(10) Pub. No.: US 2020/0026274 A1
(43) Pub. Date: Jan. 23, 2020

(54) AUTONOMOUS DRIVING COMPUTATIONAL METHOD OF VEHICLE USING GRAVITATIONAL FIELD THEORY

(71) Applicant: Hirotaka KITAGAWA, matudo-shi (JP)

(72) Inventor: Hirotaka KITAGAWA, matudo-shi (JP)

(21) Appl. No.: 16/556,229

(22) Filed: Aug. 30, 2019

Related U.S. Application Data
(63) Continuation of application No. PCT/JP2017/016329, filed on Apr. 25, 2017.

(51) Int. Cl. G05D 1/00

(52) U.S. Cl. CPC G05D 1/0055; G05D 1/0088

(57) ABSTRACT

A generation positon of a gravity and an observation position are appropriately specified according to traffic environment and traffic rules. Thus, safety autonomous driving is enabled based on Theory of Relativity (gravitational field theory).

### CROSS-REFERENCES TO RELATED APPLICATIONS

This Application claims the benefit of priority and is a Continuation application of the prior International Patent Application No. PCT/JP2017/016329, with an international filing date of Apr. 25, 2017, which designated the United States, the entire disclosures of all applications are expressly incorporated by reference in their entirety herein.

### BACKGROUND OF THE INVENTION

### 1. Field of the Invention

The present invention is for operating an autonomous driving of vehicles safely and most appropriately.

### 2. Description of Related Art

For putting the autonomous driving of the automobiles into practical use, a method for judging the most appropriate operation is required while maintaining the perfect consistency of various conditions which cannot be integrated. The various conditions are not only “safety of own vehicle” but also “safety of pedestrians and obstacles,” “traffic rules,” “morals” and “weather,” for example.

However, the consistency cannot be maintained in the conventional algorism of the autonomous driving since individual judgement theory is included in each of the above described conditions.

In the present invention, the perfect consistency can be maintained by capturing and quantifying all conditions only by “gravitational field theory.”

The autonomous driving can be practically used to a certain extent by the fundamental settings (basic settings and on-road settings) described in the specification of the present invention.

However, the fundamental settings should be mastered in order to appropriately specifying “gravity-generating points and values” and “observation positions” for the unspecified conditions which are not described in the specification.

If the fundamental settings can be mastered, they can be flexibly applied and expanded to “traffic rules,” “morals” and “additional matters occur in the future” in all countries.

Accordingly, the fundamental settings are the core of the present invention, the text book and the necessary factor for industrial applicability.

The present invention uses a sum value of “individual” and “whole” increase rates for the judgement method for identifying the most appropriate operation.

The conventional technology uses only “individual” for the judgement. However, since “whole” is included according to the conditions, the most appropriate operation can be identified wider in the area and deeper in future prediction.

Non-patent Document 1: Fundamental physical equation “Theory of Relativity, Gravitational field theory” Inventor: Dr. Einstein

### BRIEF SUMMARY OF THE INVENTION

The present invention provides an autonomous driving computational method for performing an autonomous driving of a vehicle, wherein for capturing a condition of running the vehicle by a gravitational field theory, based on the condition, gravity-generating points are specified on an obstacle position to be avoided, a white line position and an own vehicle position in a real space of running the vehicle, and a velocity designated position, a brake pedaling designated position, an acceleration pedaling designated position, a steering operating designated position and a vehicle inclination designated position in a virtual space of table calculation, based on the gravitational field theory, a gravity value generated by a gravity is observed and quantified at the own vehicle position and the obstacle position in the real space and observed at the velocity designated position, the brake pedaling designated position, the acceleration pedaling designated position, the steering operating designated position and the vehicle inclination designated position in the virtual space to integrate a distance, a velocity and an angle by judging an increase rate.

### BRIEF DESCRIPTION OF THE DRAWINGS

FIG. 1 is a view conceptually showing Theory of relativity (Gravitational field theory).

FIG. 2 shows a vehicle is specified in a three-dimensional space.

FIG. 3 shows a setting of a white line.

FIG. 4 shows observation positions of the vehicle.

FIG. 5 shows observation positions of the vehicle.

FIG. 6 shows observation positions of the vehicle.

FIG. 7 shows whole observation settings.

FIG. 8 is a view conceptually showing a method of avoiding dangerous gravities.

FIG. 9 is a view conceptually showing a method of avoiding dangerous gravities.

FIG. 10 shows a setting of static obstacle.

FIG. 11 shows a setting of dangerous gravities specified on static obstacle.

FIG. 12 shows obstacle whole settings and obstacle individual settings.

FIG. 13 shows a setting of dangerous gravities specified on own vehicle.

FIG. 14 shows a setting of dangerous gravities specified on own vehicle.

FIG. 15 shows a setting of dangerous gravities specified on own vehicle.

FIG. 16 shows a prediction of an appropriate operation.

FIG. 17 shows a setting of static human.

FIG. 18 shows a setting of dangerous gravities specified on static human.

FIG. 19 shows a setting of moving obstacles.

FIG. 20 shows a prediction of moving range of the moving obstacle.

FIG. 21 shows a prediction of moving range of the moving obstacle.

FIG. 22 shows a setting of moving human.

FIG. 23 shows a setting of moving vehicle as an obstacle.

FIG. 24 shows a setting of plural obstacles.

FIG. 25 shows a setting of red signal.

FIG. 26 shows a setting of red signal.

FIG. 27 shows final judgement of red signal.

FIG. 28 shows a setting of yellow signal.

FIG. 29 shows a setting of mandatory stoppage.

FIG. 30 shows a setting example of limit distance.

FIG. 31 shows final judgement of mandatory stoppage.

FIG. 32 shows a setting of dangerous gravity value.

FIG. 33 shows a setting of inclination of vehicle.

FIG. 34 shows a setting of slope and step.

FIG. 35 shows a setting of riding over foreign matter or hole.

FIG. 36 shows a setting of riding over foreign matter or hole.

FIG. 37 shows a setting of wind.

FIG. 38 shows a setting of wind.

FIG. 39 shows a setting of dangerous gravities specified on wind.

FIG. 40 shows a setting of dangerous gravities specified on wind.

FIG. 41 shows a setting of vehicle distance.

FIG. 42 shows a setting of vehicle distance.

FIG. 43 shows a setting of center traveling.

FIG. 44 shows a setting of center traveling.

FIG. 45 shows a setting of lane change.

FIG. 46 shows a setting of lane change.

FIG. 47 shows a setting of lane change.

FIG. 48 shows a setting of route.

FIG. 49 shows a setting of route.

FIG. 50 shows a setting of route.

FIG. 51 shows a setting of dead angle.

FIG. 52 shows a setting of elimination of mental dissatisfaction.

FIG. 53 shows a setting of consideration driving.

FIG. 54 shows a setting of consideration driving.

FIG. 55 shows a setting of consideration driving.

FIG. 56 shows a setting of consideration driving.

FIG. 57 shows a setting of selection by age.

FIG. 58 shows a setting of temperature sensor.

FIG. 59 shows a setting of temperature sensor.

### DETAILED DESCRIPTION OF THE INVENTION

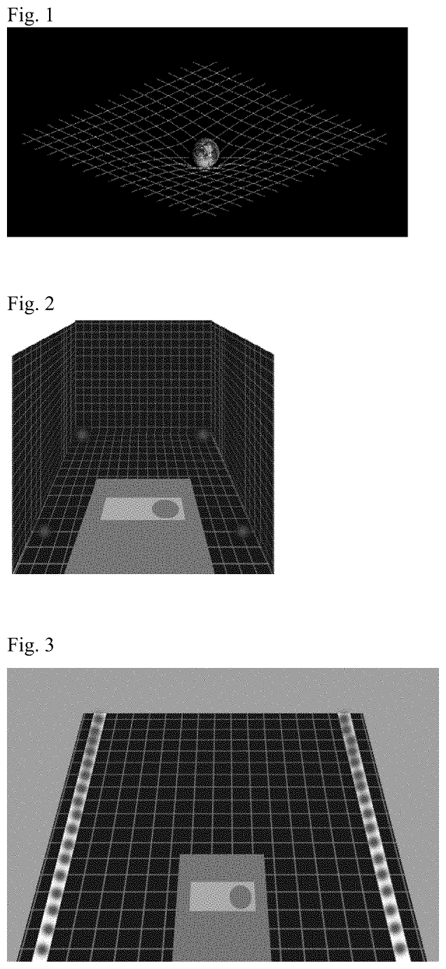

In the algorism of the present invention, Theory of relativity (Gravitational field theory) is used for the fundamental settings of the space. (See FIG. 1)

$${G}_{μ v} + Λ {g}_{μ v} = \frac{8 π G}{{c}^{4}} {T}_{μ v} \qquad ( Formula 1 )$$

When the above described equation is used, the following features can be seen:
Stronger as the distance approaches
Mutually affected
0 does not occur

A vehicle is specified in a three-dimensional space. Although the number of input constants for arranging dangerous gravities based on the traffic rules is not limited, the basic values are specified to be same (except for the intentional comparison of the dangerous gravity). See “Basic settings 12: Dangerous gravity value.” It is possible to give the priority to easiness of view and easiness of recognition when three-dimensionally displayed. (FIG. 2 is the preferable state.)

### Basic Settings 1: White Line

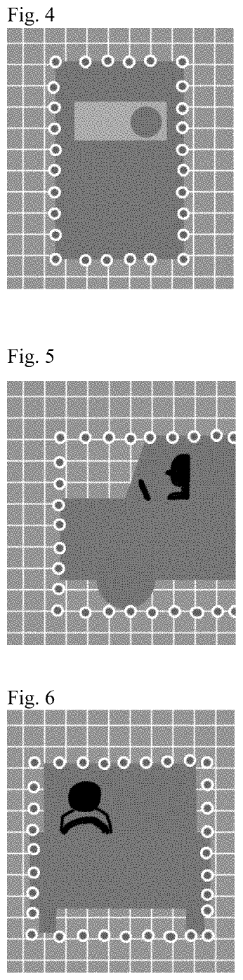

A white line which is the most general limitation is specified. (See FIG. 3)

The dangerous gravities are arranged at proper intervals along the center (or the inside) of the white lines. Although the interval depends on the minimum unit of the three-dimensional space, the interval is provisionally considered to be 5 cm. After actually experimented, the interval can be increased to 10 cm or reduced to 3 cm, for example. The minimum unit of the three-dimensional space is the most appropriate when the calculation is possible in the proper speed while balancing the performance of the PC to be used and the valued of 7C to be inputted.

Then, the observation positions of the vehicle are specified. (See FIGS. 4, 5 and 6)

The observation positions are specified around the vehicle by the unit of 5 cm, same as the white line. Consequently, the vehicle is as if wrapped by the three-dimensional space. The numbers are assigned to the observation positions so that the observation positions are controlled individually.

### Whole Observation Settings

TABLE 1

| | current value | left | front | right |
|---|---|---|---|---|
| 1 | 10 | 15 | 10 | 10 |
| 2 | 10 | 10 | 10 | 15 |
| 3 | 10 | 10 | 5 | 10 |
| 4 | 10 | 10 | 10 | 10 |
| 5 | 10 | 10 | 10 | 10 |
| 6 | 10 | 10 | 10 | 20 |
| 7 | 10 | 10 | 10 | 10 |
| 8 | 10 | 10 | 10 | 10 |
| | sum 80 | 85 | 75 | 95 |

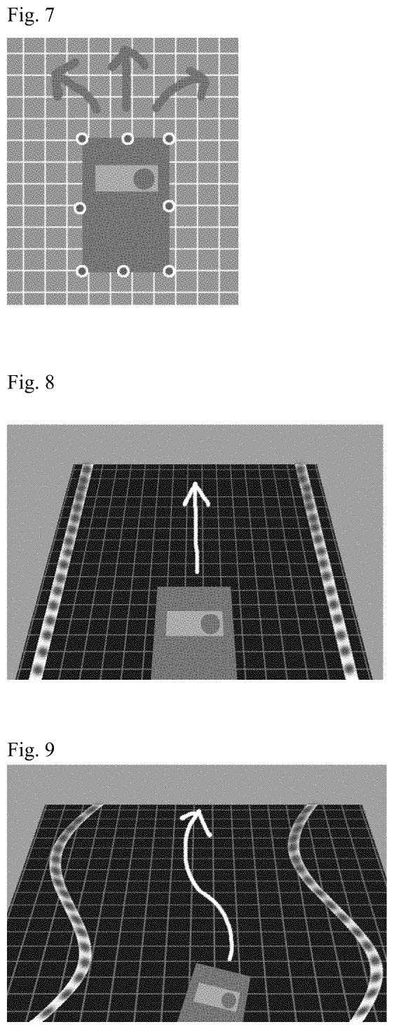

FIG. 7 is an example of an extremely simple specification. Suppose that the number of the observation positions of the vehicle is only eight and the operation of the vehicle is limited to left, forward and right.

The values can be measured for each observation position by the dangerous gravities arranged on the white line. Here, all of “current value” are specified to 10 for making the explanation extremely easier. When the prediction values are calculated for the options of “left,” “front” and “right,” the dangerous value is the lowest: “75” when “front” is selected. Thus, the result tells that the most appropriate operation is to select “front.”

In the actual judgement, the increase rate of the average value in all the observation positions is used without using the sum of all the observation positions.

TABLE 2
Individual observation settings

| | current value | left | front | right |
|---|---|---|---|---|
| 1 | 10 | 15 | 10 | 10 |
| | | dangerous value | | |
| | | +50% | 0% | 0% |
| 2 | 10 | 10 | 5 | 10 |
| | | dangerous value | | |
| | | 0% | −50% | 0% |
| 3 | 10 | 10 | 10 | 20 |
| | | dangerous value | | |
| | | 0% | 0% | +100% |

The increase rate of the dangerous value is calculated for each of the observation positions.

Final Judgement in this Situation

The most appropriate operation is determined by the best value by referring both the whole and individual increase rates. In this example, the judgment is made by judging the sum of the increase rates in nine positions.

In order to avoid “error of algorism” in the autonomous driving of the vehicle, the theory adopting the concepts of the above described “gravitational field theory,” “whole” and “individual” is necessary. The accident cannot be prevented by the algorism currently developed by automobile manufacturers. This is because the following philosophical question arises. Can the change formed by π be appropriately observed by using rational numbers?

As everybody knows, π is irregular and the irrational number. Thus, in order to observe π, π should be used. This cannot be avoided in any methods.

The most appropriate method to avoid the dangerous gravities can be predicted by the sum value of “whole” and “individual” increase rates. (See FIGS. 8 and 9)

### Basic Settings 2: Static Obstacle

As shown in FIG. 10, this is the setting for the static obstacles placed on the road.

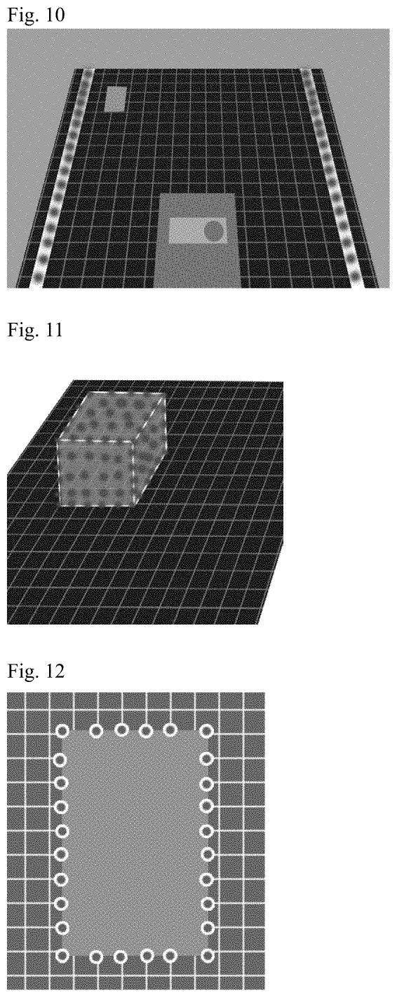

The dangerous gravities are specified on the recognizable surface of the obstacle by the unit of 5 cm. (See FIG. 11)

Consequently, the dangerous value affected to the vehicle can be predicted same as the setting of the white line. (The settings are same as the white line.)

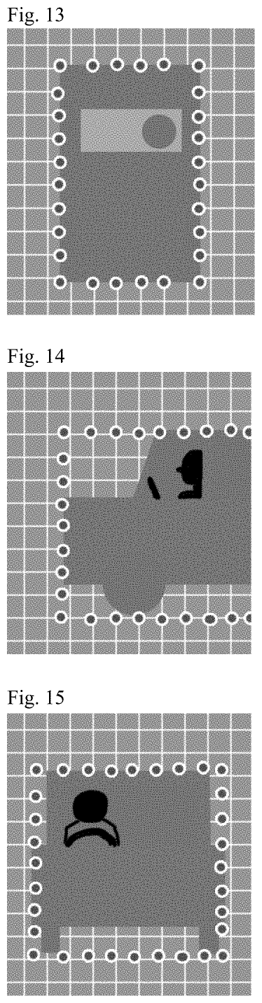

Furthermore, “obstacle whole settings” and “obstacle individual settings” are added. They are three-dimensionally specified same as the observation positions. (See FIG. 12)

It is enough to add the settings within a recognizable range.

Then, the dangerous gravities are specified on the own vehicle. (See FIGS. 13, 14 and 15)

As for the static obstacles, the value of the observation position is influenced by the own vehicle. Of course, it is not influenced by the dangerous gravities of the white line.

Final Judgement in this Situation

The most appropriate operation can be identified by the prediction value calculated by summing up all increase rates. The objects to be calculated increase as the number of the static obstacles increases. (See FIG. 16)

Consequently, the vehicle runs on the route to protect the security of the obstacles while following the traffic rules.

### Basic Settings 3: Static State, Human

The human is the obstacle but more than the obstacle. Therefore, the setting of “life” is added. (See FIG. 17)

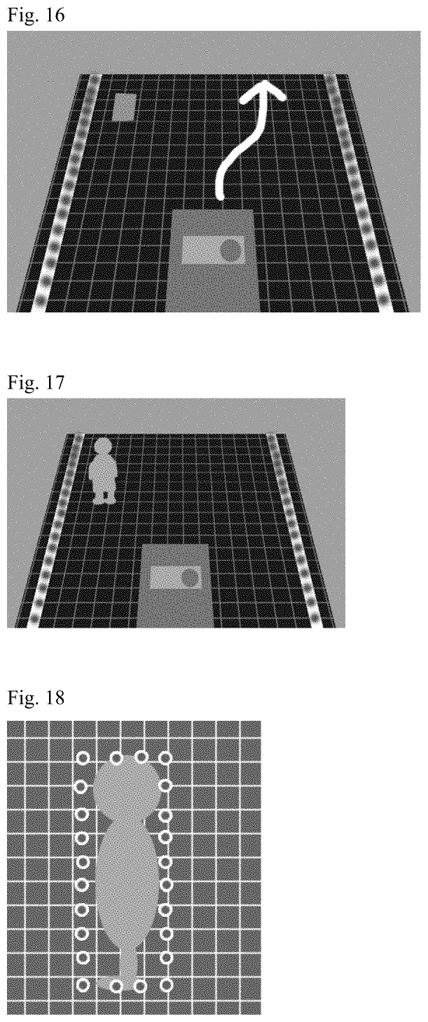

The settings are same as the static obstacles until the middle way. (See FIG. 18)

The observation positions are three-dimensionally specified. Similarly, the dangerous gravities are specified. In the case of the human, the setting of “life” is additionally specified.

The reason why the human (static object) is separated from the life will be explained later. See “Basic settings 12: Dangerous gravity value.”

### Basic Settings 4: Moving Obstacles

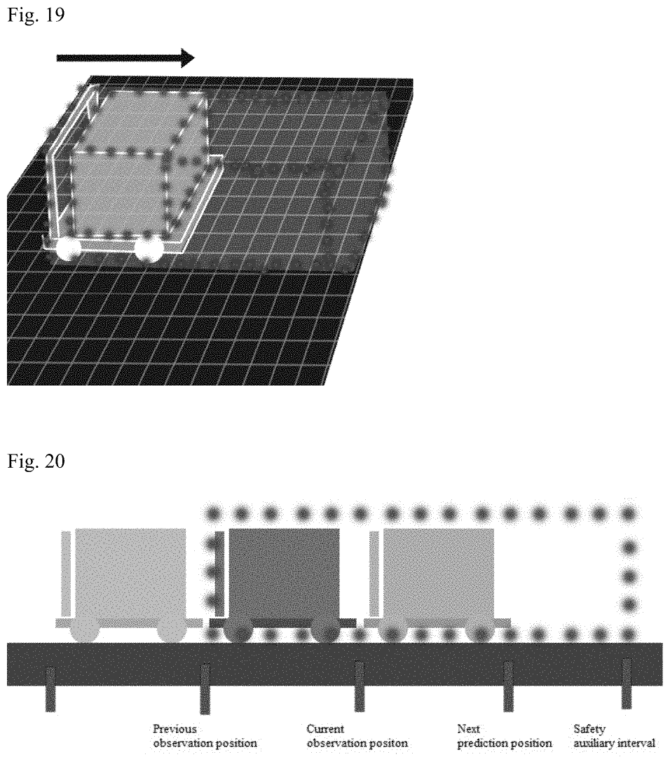

In FIG. 19, only the front linear direction is considered for the moving direction.

(See FIG. 20)

As shown in FIG. 20, the moving range of the moving obstacle is predicted and sufficient auxiliary interval is provided. They are treated as one obstacle as a whole. If the speed (velocity) is high, the moving range becomes long.

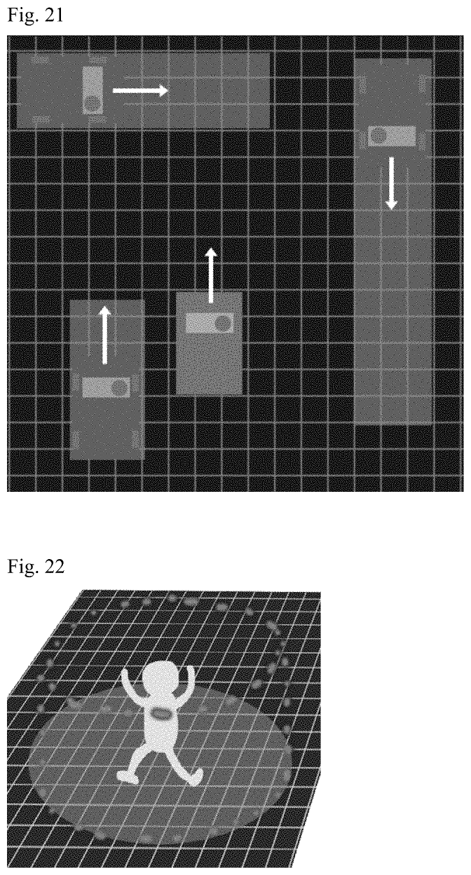

Even if the speed is the same, the auxiliary interval varies according to the moving direction. (See FIG. 21)

The other settings and the calculations are same as the static obstacles.

### Basic Settings 5: Moving State, Human

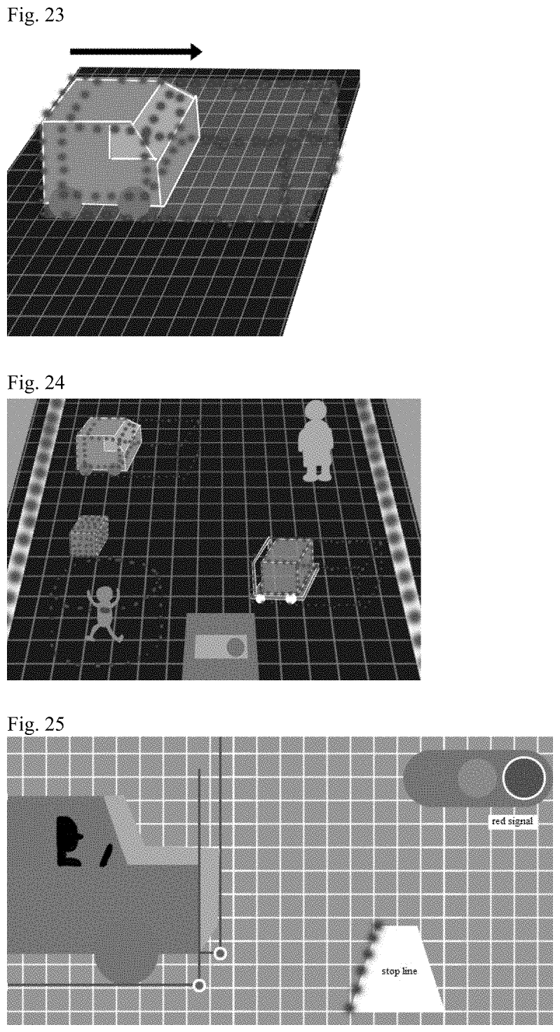

In case of the human (especially children), it is difficult to predict the moving direction. Thus, a sufficient interval is kept considering the movement of all directions. (See FIG. 22)

The other settings and calculations are same as Static state, Human.

### Basic Settings 6: Moving Obstacle, Vehicle

In case of the moving vehicle, the human is riding on the vehicle with a high possibility. Thus, the setting of “life” is added regardless of the recognition of the human. (See FIG. 23)

The other settings and calculations are same as Moving state, Human.

Since the moving directions of the vehicle are various, the setting range of the dangerous gravities are extended to the right and left. However, the directions can be limited considerably based on the traffic rules.

### Basic Settings 7: Plural Obstacles

(See FIG. 24)

Final judgement for plural obstacles

As described above, the number of obstacles can be increased indefinitely. However, since the calculation speed decreases as the objects to be judged increase, it is efficient to simplify the setting of the gravity for the obstacle located too far, for example.

The front, left and right sides of the vehicle and the human should be emphasized (depending on the performance of PC).
Basic Settings 8: Speed Limit

The limit of the speed is specified. The gravity of observing the traffic rules, the current speed and the observation position are shown. As the drivers observes the legal speed, the speed becomes more appropriate.

In order to stably maintain the above described state, the following three settings are prepared.

The operations of the acceleration and the brake are specified. It is said that the pedaling should be avoided as much as possible for the safety operation.

The traveling stability is further applied.

The legal speed is assigned to 0%, and the speed of 0 km/h is assigned to 100%. Consequently, the safety speed of the current vehicle can be calculated by percentage (%). If the road for running by the speed of 60 km/h, a certain pedaling position is the most appropriate pedaling degree.

The speed matched with the flow of traffic will be explained later. See “On-road settings 2: Following flow.”

### Basic Settings 9: Red Signal

As for the red signal, the stop operation is performed by specifying the legal speed to 0. In addition, the setting of “traffic rules observation” is added. This is the setting for minimizing the distance between the vehicle and the stop line as short as possible. (See FIG. 25)

The observing gravity is specified to the position before the stop line. The observation points are specified on both lateral sides of the lower part of the vehicle. The traffic rules are observed by reducing the distance from the stop line to one of the both lateral sides further from the stop line.

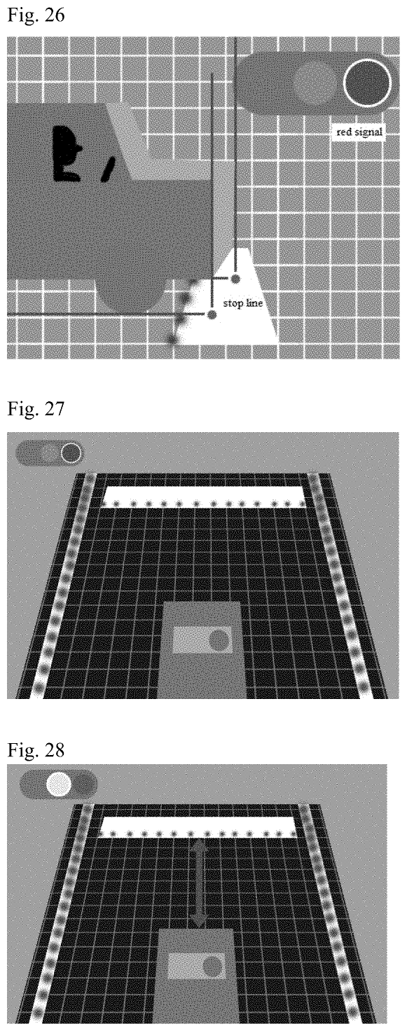

In this case, the value becomes lower and the operation becomes more inappropriate as the distance from the stop line becomes longer. As an insurance, it is good for specifying not to move backward during the red signal. By combining the above described two settings, the vehicle can be stopped at an appropriate position with respect to the red signal. (See FIG. 26)

Final Judgement in this Situation

(See FIG. 27)

The judgement under the above described situation is as shown below.

### Basic Settings10: Yellow Signal

As for the yellow signal, the distance to the stop line is preliminarily determined for each speed. It is enough only to decide whether the vehicle passes through the stop line or stopped at the stopped line in each speed. (See FIG. 28)

### EXAMPLE

When the vehicle runs at the speed of 50 km/h and the yellow signal is recognized within the distance of 20 m to the stop line, the yellow signal is ignored and the vehicle passes through the stop line.

When the distance to the stop line is 20 m or more, the signal is regarded as the red signal and the vehicle stops.

### EXAMPLE

When the vehicle runs at the speed of 30 km/h and the yellow signal is recognized within the distance of 10 m to the stop line, the yellow signal is ignored and the vehicle passes through the stop line.

When the distance to the stop line is 10 m or more, the signal is regarded as the red signal and the vehicle stops.

### Basic Settings 11: Mandatory Stoppage

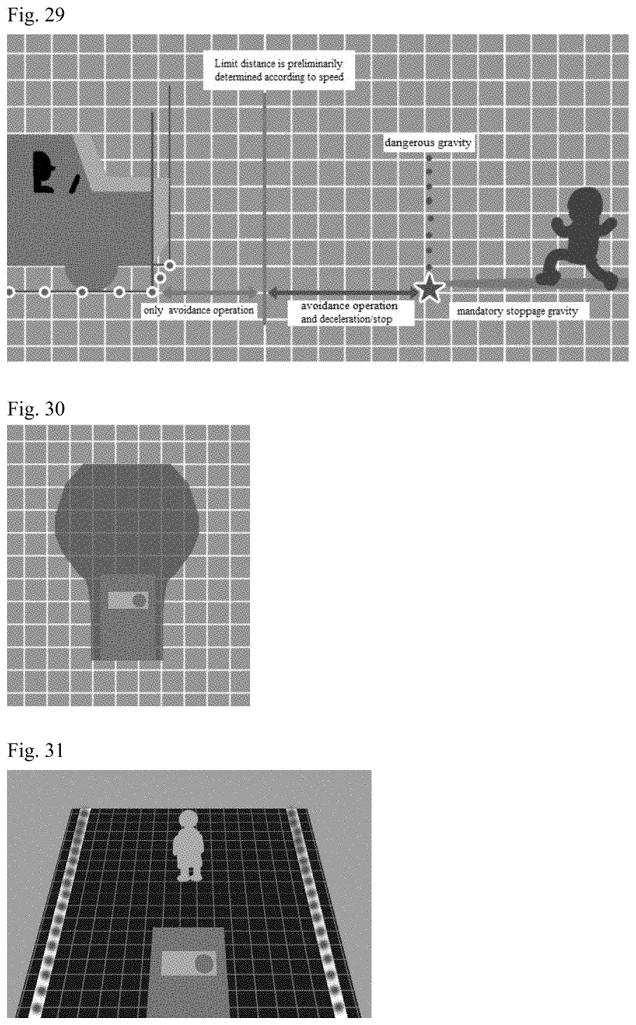

This is the setting for preventing the vehicle from approaching the obstacles and the human too closely. Same as the yellow signal, the limit distance is preliminarily determined for each speed. (See FIG. 29)

The mandatory stoppage gravity (star mark) is generated at the lowermost part of the position of generating the dangerous gravity of the obstacle. The observation position is on the line of the lower part of the entire vehicle. All obstacles and the human are independently observed. If even one of them enters in the limit distance, the vehicle slows down and stops while avoiding the obstacles and the human. Since the lateral sides are mainly for preventing the involvement, it is not necessary to specify the limit distance to the front.

### Setting Example of Limit Distance

If the setting speed of the limit distance increases, the range is expanded frontward considerably. If the steering is turned left or right, the limit distance of the lateral side is expanded. (See FIG. 30)

When the obstacles enter in the limit distance, deceleration operation is forced. Consequently, the speed set to the vehicle decreases and the vehicle stops when comes close to the star mark. Even if it exceeds the dangerous gravity, the mandatory speed is still set to 0. Therefore, the stoppage is necessarily kept.

In order to surely avoid the contact with the obstacles, it is important to specify the limit line having an enough distance. It is not always true that “exceeding limit line=vehicle stops.” While decreasing the speed, the avoidance traveling is continued.

In case of sudden running-out of short distance, quick brake may not be in time and the contact may occur. However, there is no way to avoid the contact on the vehicle side.

Final Judgement in this Situation (See FIG. 31)

### Basic Settings 12: Dangerous Gravity Value

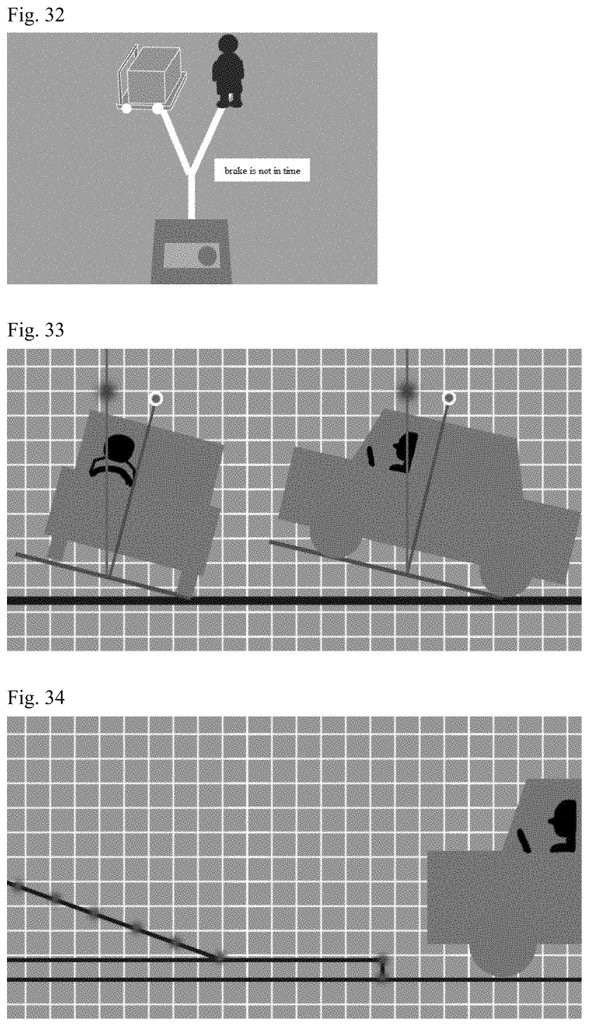

The gravity values specified to the obstacles and human need a variation. (See FIG. 32)

When the brake is not in time and we should select one of two, which one should we save? For the selection, the gravity should be changed according to the kind of the obstacles.

Gravity value 1: white line, no-passing lane

Gravity value 2: luggage, guardrail

Gravity value 3: human, running vehicle, animal

The above described list is merely example. A lot of discussion is needed for the selection.

Furthermore, the gravity should be changed for “life.’

Gravity value 1: animal

Gravity value 2: vehicle running in the same direction (relatively strong against impact)

Gravity value 2: human (not strong against impact), running vehicle (head-on collision is very dangerous)

For clearly distinguish the life of the human with the life of the others, a priority can be given to the human by adding the setting of “Life, Human.”

### Basic Settings 13: Steering Operation

As for the steering, straight is the safest and turning too much is not good.

Appropriateness for turning the steering is maintained by the above described setting.

### Basic Settings 14: Inclination of Vehicle

Horizontal is the safest. The setting is made for maintaining the horizontal. (See FIG. 33)

The degree of the inclination is measured by drawing a reference line on the center of the vehicle.

### Basic Settings 15: Slope, Step

The dangerous gravity is specified to all recognizable slopes and steps. The mandatory stoppage gravity is added according to the angle and height. (See FIG. 34)

### EXAMPLE

The slope of less than ?° is treated as the road. The mandatory stoppage gravity is added for the slope of ?° or more to avoid it as an obstacle.

### EXAMPLE

The mandatory stoppage gravity is added when the step is 5 cm or more to avoid it as an obstacle. When the step is less than 5 cm, it is judged as passable but the passing speed is reduced to 5 km/h or less. When the step is 3 cm or less, it is judged as passable but the passing speed is reduced to 10 km/h or less. When the step is 1 cm or less, it is judged as passable but the passing speed is reduced to 30 km/h or less.

### Basic Settings 15: Riding Over Foreign Matter or Hole

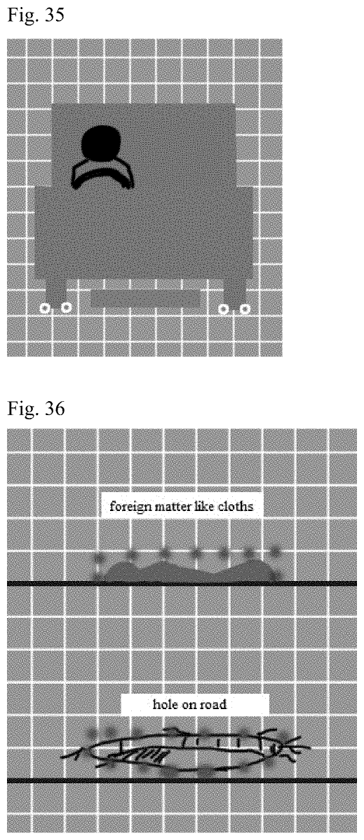

This is the setting for riding over the static foreign matters lying on the road (height: approximately 10 cm or less) or holes (depth: approximately 10 cm). (See FIGS. 35 and 36)

The size of obstructing the running of the vehicle is preliminarily checked. If the size is less than that, the vehicle can ride over it. This is the method when the vehicle cannot avoid the foreign matter from lateral sides. Of course, the riding is not allowed when the foreign matter is recognized as the moving object. The above described setting is not good from the viewpoint of the traffic rules. However, if the above described setting is not specified, the vehicle stops even for the tiny obstacle and prevents the traffic.

In case of the hole on the road, it is safe to reduce the speed when passing through it.

The observation position is the width of the front and rear tires. It is possible to ride over the hole if it can be judged to be safe when it is checked. However, the speed should be reduced.

### Basic Settings 16: Weather

Settings for wind, rain, snow, freeze and so on.

### “Wind”

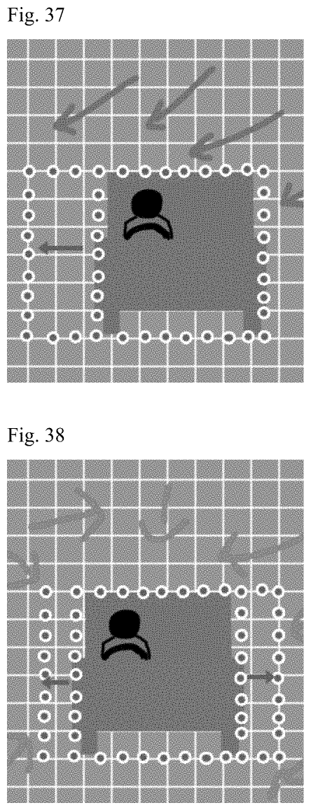

When the cross wind blows, the observation position is broaden to the lee side to make a margin. (See FIG. 37)

When the wind is disturbed such as typhoon, the observation position is broaden in right and left and front and back directions. (See FIG. 38)

The legal speed is preferred to be reduced by 10% to 30%. This can be adjusted according to the strength of the wind.

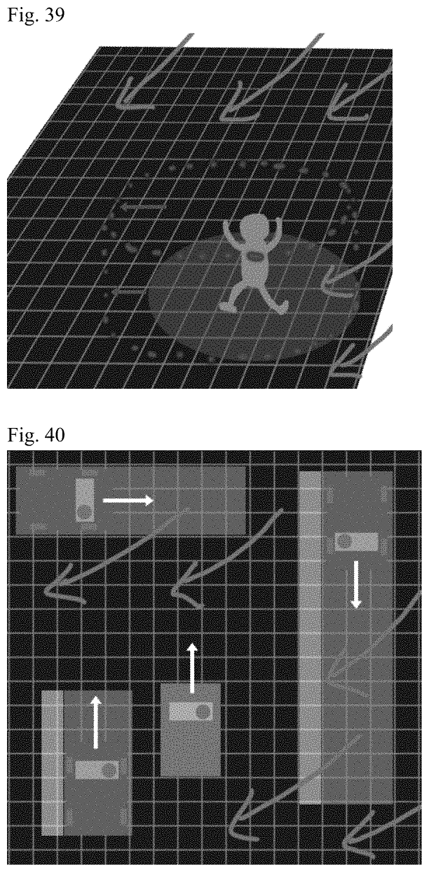

The range of the dangerous gravity is broaden also for the obstacles. (See FIG. 39)

This is same for the moving objects. (See FIG. 40)

### “Rain” and “Snow”

Since the vehicle is easily slipped, the observation position is broaden in right and left and front and back directions same as “Wind.” The legal speed is preferred to be reduced by 10% to 30%.

In case of a puddle, the settings are same as “Basic settings 15: Riding over foreign matter or hole.” For the puddle, the setting to allow to ride over the puddle should be prepared. The vehicle passes through the puddle while the speed is reduced.

The mandatory stoppage gravity is applied when the puddle seems to be too large or too deep to avoid it as an obstacle.

### “Freeze”

Basically, the freeze is same as the puddle, but the freeze is very dangerous. Therefore, the speed is preferably reduced to 50% or less (30 km/h or less).

When the road is frozen, the range of the dangerous gravity of the obstacles is further broaden. The range of the running vehicle is also further broaden and the safety should be emphasized.

### On-Road Settings 1: Vehicle Distance

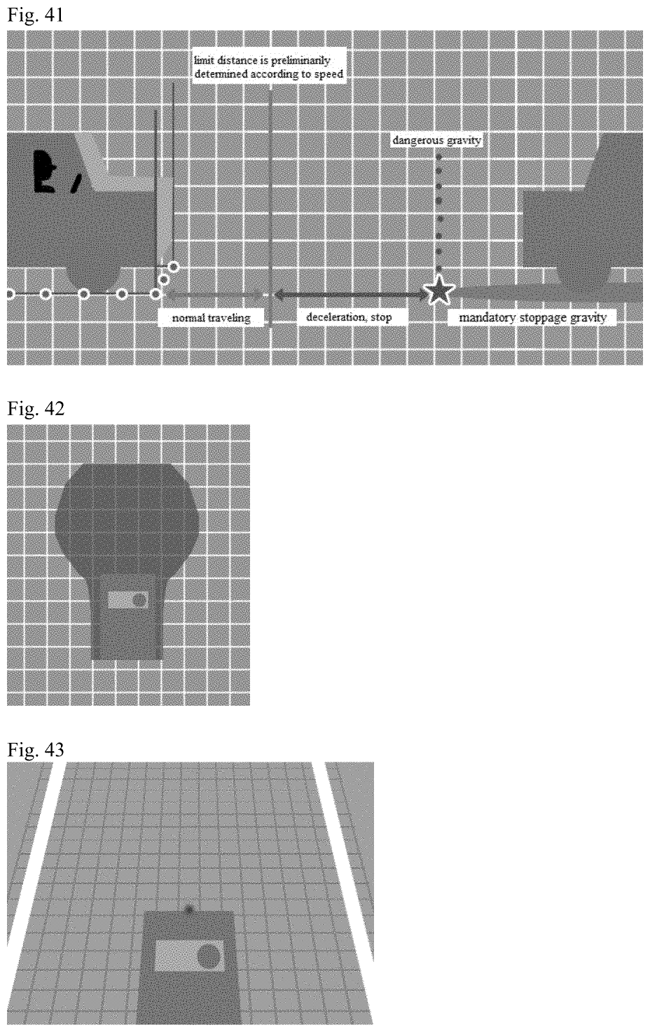

The vehicle distance is almost same as “Basic settings 11: Mandatory stoppage.” The other vehicles are treated as the moving obstacles to track them. Thus, the own vehicle keeps an appropriate distance from the other vehicles and stops before them. (See FIG. 41)

### Setting Example of Limit Distance

The limit distance of lateral sides is also required. (See FIG. 42)

When the other vehicles enter in the limit distance, deceleration operation is forced. Consequently, the speed set to the vehicle decreases and the vehicle stops when comes close to the star mark.

### On-Road Settings 2: Following Flow

To follow the flow means that the vehicle runs at a speed exceeding the legal speed. In advance, the allowable range of overspeed (how much km/h) is preliminarily determined.

The speed of the preceding vehicle is measured. Then, whether or not the measured speed is within the allowable range is judged. Next, the speed of the following vehicle is also measured. Then, whether or not the measured speed is within the allowable range is judged. The more stable speed (lower speed) is selected from the front and following vehicles. Then, the own vehicle follows the selected vehicle by correcting the running speed. Thus, the own vehicle can follow the flow.

If the preceding or the following vehicle is less than the legal speed, it is better to run at the legal speed without exceeding the legal speed.

### On-Road Settings 3: Center Traveling

The center gravity is specified to the center of the traveling road. (See FIG. 43)

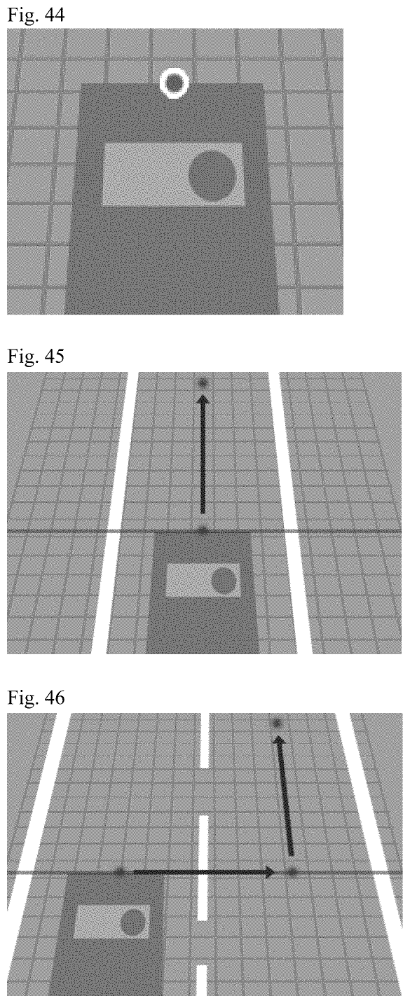

The observation position is the center of the front part of the vehicle. Consequently, the priority is given to travel the center. When vehicle travels the center, the center gravity is overwrapped with the observation position. (See FIG. 44)

### On-Road Settings 4: Lane Change

When the position of the center gravity is shifted, the lane change is automatically performed. (See FIG. 45)

(See FIG. 46)

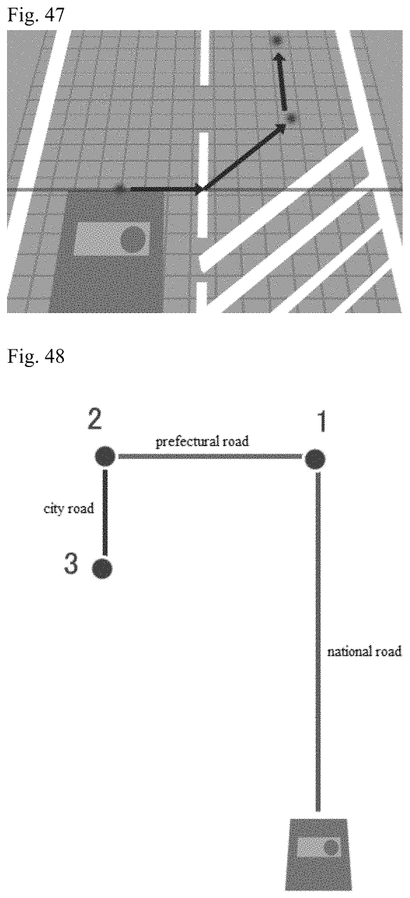

(See FIG. 47)

### On-Road Settings 5: Passing

When the difference between the legal speed and the measured speed of the preceding vehicle is less than the preliminarily specified value, the own vehicle passes through the preceding vehicle. Same as the lane change, when the position of the center gravity is shifted, the passing is performed. Of course, the center gravity cannot be shifted crossing the no- passing lane.

### On-Road Settings 6: Route

In the autonomous driving of the vehicle, a navigation is equipped in many cases. However, the setting method for the case where the navigation is not equipped will be explained.

First, the designation is roughly decided. In FIG. 48, the setting is “runs on the national road toward 1.”

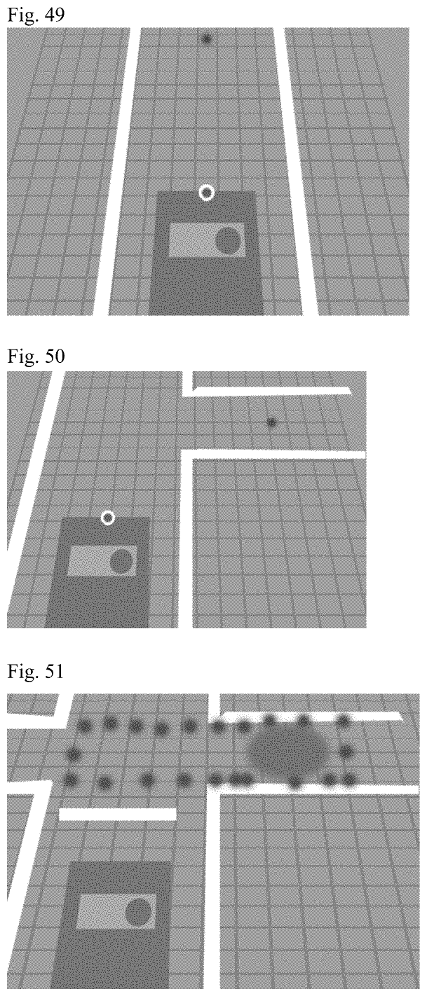

A route gravity is generated on an approximately 10 m forward in the direction toward the destination. The observation point is the center of the front part same as the center traveling. The route gravity is generated on the appropriate traveling lane and road based on road signs and so on. (See FIG. 49)

When the route is curved, the route gravity turns in advance to function as a guidepost and the vehicle follows the route gravity. The route gravity always guides 10 m forward the vehicle including an appropriate lane. (See FIG. 50)

After arrived at the destination 1, the vehicle then follows 2. Consequently, the vehicle can arrive at the final destination.

### On-Road Settings 7: Dead Angle

The dangerous gravity is specified on the dead angle position at a short distance. (See FIG. 51)

The dead angle is treated as if the static obstacle exists. On the traveling road, the priority is given to the safety by specifying the dangerous gravity according to the legal speed. When it is confirmed that there is nothing in the dead angle position, the dangerous gravity disappears and the increase rate is set to 100%.

Since there is no end to care much about the dead angle, a certain looseness is needed for identifying the dead angle.

### Extralegal Measures 1: Elimination of Mental Dissatisfaction

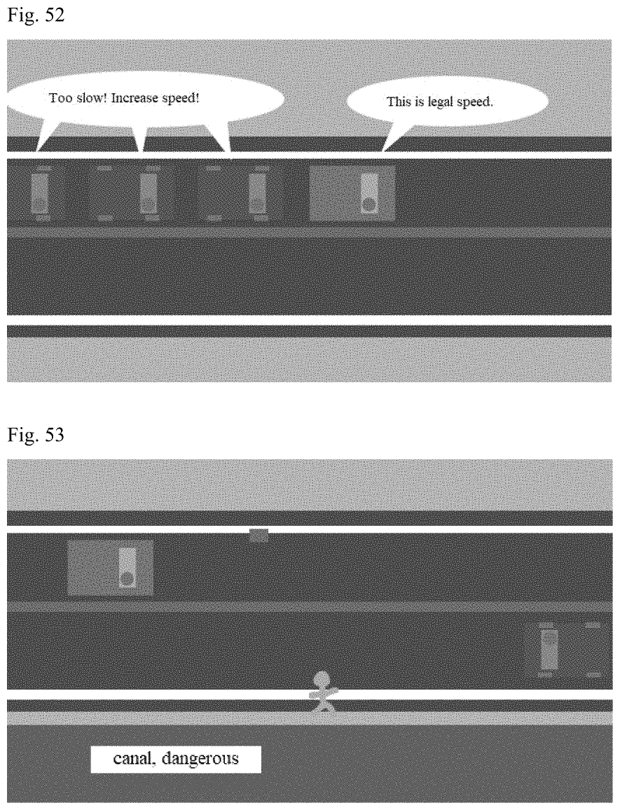

Considering the case when the own vehicle is the top of a vehicle line in the setting of Following flow. Of course, the speed is the legal speed and the lane is no-passing lane. (See FIG. 52)

If the speed is increased in this state, the own car actively commits a speeding violation. How the own car should operate in this case? How the own car should operate if the traffic jam occurs in the following vehicles? How much km/h of the speed violation is allowed? The decision should be made after having a discussion with the government. Probably, it is appropriate to obey the legal speed in the current traffic rules.

If there are preceding and following vehicles, the speed violation tends to be accepted since the own vehicle is recognized as “a part of the group.” However, if the own car is the top of the vehicle line, the own vehicle is hardly recognized as “a part of the group.” In the first place, whether or not the following vehicles have a complaint cannot be checked.

Therefore, it is unnecessary to care about the complaint. Since the autonomous driving, it is bothersome to “take care of the human.”

### Extralegal Measures 2: Consideration Driving

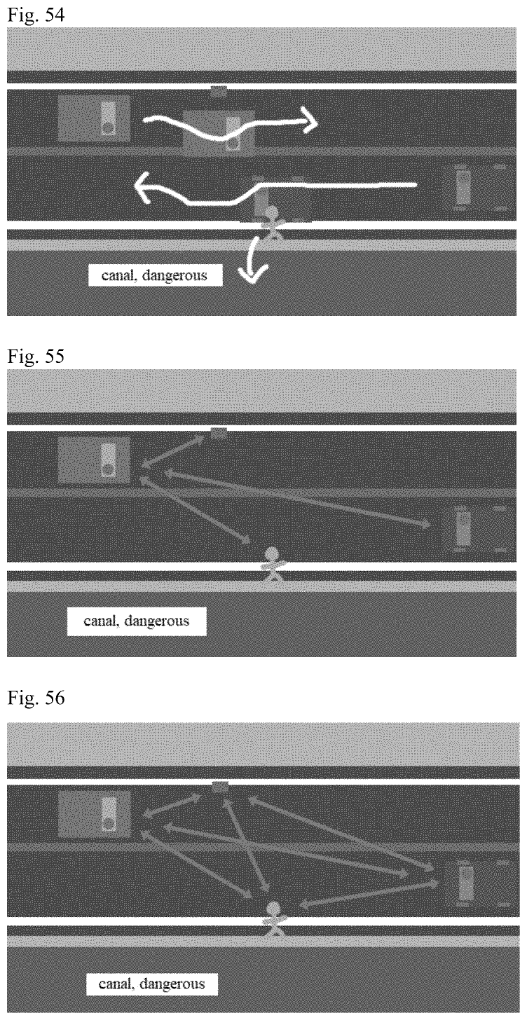

In the case shown in FIG. 53, the operation described in FIG. 54 is performed in the current low.

People far from the vehicle may be exposed to dangers. It is merely possibility since it depends on the oncoming vehicle. If the priority is given to the human life, it is the best way to stop before the obstacle and let the oncoming vehicle escape. However, it prevents the smooth driving of other vehicles. It is not appropriate for the traffic rules (interruption of following vehicles).

The above described problem cannot be solved at once. However, the traffic rules should be changed in the future to cope with the above described problem.

### Current Mechanism (See FIG. 55)

Future mechanism (See FIG. 56)

This depends on the performance of the PC since the amount of the calculation increases explosively by doing this. If the oncoming vehicle is equipped with the autonomous driving, the communication is possible. Since the oncoming vehicle may be driven by the human, the calculation and judgement should be made independently only by the own vehicle.

### Extralegal Measures 3: Selection by Age

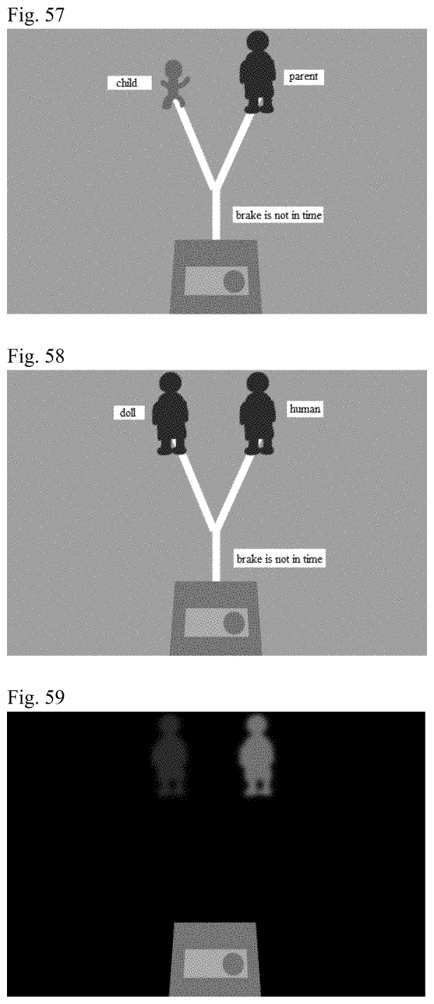

Considering the case shown in FIG. 57.

Which is protected and which is sacrificed? Ethically, the child should be protected and the parent should be sacrificed. (Then, the left children are grown by the society.) However, this cannot be clarified by the current law. Therefore, it is innocuous to randomly cope with that.

If it is not avoidable to widely spreading the autonomous driving vehicles, clear answer should be prepared for the above described difficult question and an appropriate system should be mounted on the vehicles. The human species need new ethics view.

The priority for the parent and child is distinguished by the input value of the dangerous gravity.

### Extralegal Measures 4: Obligation of Temperature Sensor

A serious accident may occur if the judgement is made only by visible light. Therefore, “temperature sensor” should be obligated for all autonomous driving vehicles in the future to clearly distinguish human/creature with others. (See FIG. 58)

When the temperature sensor is overlappedly used, the human can be distinguished more easily. (See FIG. 59)

### Manufacturing Autonomous Driving Apparatus for Automobile

The device can be manufactured by the above described specification. However, more detailed procedure will be additionally explained bellow.

The gravities are specified as explained in the paragraphs [0008]-[0009] of the specification. The gravities are specified on the own vehicle, other vehicles, white lines and stop lines. The value to be inputted are all the same as described in the paragraph [0005]. The gravity is specified also on the speed and the angle. The gravities are specified as described in the paragraphs [0046], [0048], [0062], [0072] and [0075]. As described in the paragraphs [0010]-[0015], [0055] and [0066], the sum of the increase rate with respect to the current value can be specified by calculating the gravity values of the observation positions after several seconds. Thus, the most appropriate autonomous driving can be achieved by repeating the steering, acceleration and braking operations having the most preferable value.

The settings are also added for the other settings such as the step, the weather, the riding over, the vehicle distance, the center traveling, the lane change, the passing, the route and the dead angle. The gravity values can be specified to be same and the settings can be increased. The gravity values can be changed as described in the paragraphs [0067]-[0071]. Even if there are any lacking settings, they can be specified by the gravitational field theory since they are all physical phenomena.

For example, when the steering operation is specified into 9 stages of “forward, right 10°, right 20°, right 30°, right 40°, left 10°, left 20°, left 30° and left 40° ” and the speed is specified into 7 stages of “acceleration+strong, acceleration+middle, acceleration+weak, acceleration+0, braking+weak, braking+middle and braking+strong,” the choices of the operations are 9×7=63 ways. The most appropriate operation can be determined from all 63 ways by calculating the sum of the increase rate of each setting after several seconds. The autonomous driving can be safely continued by repeating the above described determination at intervals of 0.5 to 1 seconds.

In the above described autonomous driving computational method, all physical phenomena related to the driving are specified on the three-dimensional space or the space of table calculation and all physical phenomena can be integrated into one function by using the gravitational field theory. In the gravitational field theory, the increase value becomes stronger as the distance between the observation position and the gravity position becomes nearer. Accordingly, the most dangerous condition is always improved to ideally perform safety driving. It can be said that the accident rate is theoretically 0% in the autonomous driving computational method of the present invention. The gravitational field theory has a feature that “measurement errors do not occur even when the settings are overlapped.”Therefore, the accident rate is kept to 0% even when the settings are added. As explained above, the autonomous driving apparatus can be manufactured.

The difference between the engine braking and the brake pedal is not considered since it depends on the performance of the automobiles.

### About Retreating Operation

The setting is turned ON when the own car stops. The observation position specified on the vehicle preceding to the own vehicle is also specified on the following vehicles. In case of retreating operation, the limit speed is limited to considerably low. Only when the own vehicle stops, the retreating operation is added to the choices of the steering operations in addition to the forward operation. The choice of the retreating operation is turned OFF during the forward running. This is because the own vehicle necessarily stops before moving backward.

When moving backward, limitations of driving time and driving distance are preferably added in addition to the limit speed. Consequently, the retreat operation is stopped appropriately and switched to the forward operation. In case of the retreat operation of the blind lane or the dead end, a provisional destination is specified. The direction of the vehicle is also specified. The vehicle moves backward toward the provisional destination. After arrived at the provisional destination, the vehicle starts toward the original destination. When the direction of the vehicle is opposite to the destination, another route can be chosen for the forward operation, or a reverse turning can be done. In case of the reverse turning, a target turning point is specified to move backward.

In the first place, the retreat operation is a phenomenon occurs when the destination is temporarily changed. Namely, the retreat operation is controlled by the route selection, destination setting and vehicle direction setting. The destination is changed when the backward operation is performed at a parking. In that case, the provisional destination is specified a plurality of times.

As explained above, the present invention is an autonomous driving computational method for performing an autonomous driving of a vehicle, wherein for capturing a condition of running the vehicle by a gravitational field theory, based on the condition, gravity- generating points are specified on an obstacle position to be avoided, a white line position and an own vehicle position in a real space of running the vehicle, and a velocity designated position, a brake pedaling designated position, an acceleration pedaling designated position, a steering operating designated position and a vehicle inclination designated position in a virtual space of table calculation, based on the gravitational field theory, a gravity value generated by a gravity is observed and quantified at the own vehicle position and the obstacle position in the real space and observed at the velocity designated position, the brake pedaling designated position, the acceleration pedaling designated position, the steering operating designated position and the vehicle inclination designated position in the virtual space to integrate a distance, a velocity and an angle by judging an increase rate.

In addition, the condition can be determined by specifying an occurrence place of the gravity and an observation position of the gravity value.

Furthermore, a plurality of observation positions of the gravity value can be specified around the vehicle for the own vehicle position and the obstacle position, a safety degree can be judged based on observation values of the gravity value observed at the plurality of observation positions by using the increase rate of an individual observation value as a judgement object for the velocity and the angle which do not have a volume and using the increase rate of the individual observation value and a whole or average increase rate of the individual observation value as the judgement object for the other integrated values.

Furthermore, the gravity-generating points can be specified only by the gravitational field theory to integrate the distance, the velocity and the angle which cannot be identified by judging the increase rate while maintaining a feature of the gravitational field theory of increasing the increase rate as an observation position approaches the gravity-generating points so that the autonomous driving of the vehicle is performed safer than a conventional method which is not specified only by the gravitational field theory.

What is claimed is:

1. An autonomous driving computational method for performing an autonomous driving of a vehicle, wherein
for capturing a condition of running the vehicle by a gravitational field theory, based on the condition, gravity-generating points are specified on an obstacle position to be avoided, a white line position and an own vehicle position in a real space of running the vehicle, and a velocity designated position, a brake pedaling designated position, an acceleration pedaling designated position, a steering operating designated position and a vehicle inclination designated position in a virtual space of table calculation,
based on the gravitational field theory, a gravity value generated by a gravity is observed and quantified at the own vehicle position and the obstacle position in the real space and observed at the velocity designated position, the brake pedaling designated position, the acceleration pedaling designated position, the steering operating designated position and the vehicle inclination designated position in the virtual space to integrate a distance, a velocity and an angle by judging an increase rate.

2. The autonomous driving computational method according to claim 1, wherein
the condition is determined by specifying an occurrence place of the gravity and an observation position of the gravity value.

3. The autonomous driving computational method according to claim 2, wherein
a plurality of observation positions of the gravity value is specified around the vehicle for the own vehicle position and the obstacle position,
a safety degree is judged based on observation values of the gravity value observed at the plurality of observation positions by using the increase rate of an individual observation value as a judgement object for the velocity and the angle which do not have a volume and using the increase rate of the individual observation value and a whole or average increase rate of the individual observation value as the judgement object for the other integrated values.

4. The autonomous driving computational method according to claim 1, wherein
the gravity-generating points are specified only by the gravitational field theory to integrate the distance, the velocity and the angle which cannot be identified by judging the increase rate while maintaining a feature of the gravitational field theory of increasing the increase rate as an observation position approaches the gravity-generating points so that the autonomous driving of the vehicle is performed safer than a conventional method which is not specified only by the gravitational field theory.
